(19) United States
(12) Patent Application Publication
(10) Pub. No.: US 2016/0270430 A1
(43) Pub. Date: Sep. 22, 2016

(54) PROCESS FOR MANUFACTURING AN AERATED FOOD PRODUCT

(71) Applicant: CONOPCO, INC., D/B/A UNILEVER, Englewood Cliffs, NJ (US)

(72) Inventor: Julian Francis BENT, Bedford (GB)

(73) Assignee: Conopco, Inc., d/b/a UNILEVER, Englewood Cliffs, NJ (US)

(21) Appl. No.: 15/034,050

(22) PCT Filed: Oct. 27, 2014
(86) PCT No.: PCT/EP2014/072995

§ 371 Date: May 3, 2016

(30) Foreign Application Priority Data
Nov. 7, 2013 (EP) 13191867.4

(51) Int. Cl. A23L 2/66; A23C 9/154; A23L 2/54; A23G 9/38; A23G 9/46; A23C 9/152; A23G 9/20

(52) U.S. Cl. CPC A23L 2/66; A23C 9/1524; A23C 9/1544; A23G 9/20; A23G 9/38; A23C 9/1526; A23G 9/46; A23L 2/54; A23C 2210/30

(57) ABSTRACT

Process for treating a food composition containing 0.01 to 15% w/w hydrophobin wherein a) the composition pH is first brought to between 1 and 4, preferably under 3.5; b) then the composition is heat treated at a temperature of at least 70° C. (preferably at least 100° C.); c) then the composition is brought to a pH of between 6 and 7.5.

### FIELD OF THE INVENTION

The present invention relates to a process for manufacturing an aerated food product. The present invention more specifically relates to a process for manufacturing an aerated food product wherein the foam is stabilised with hydrophobin. The present invention also relates to the product obtainable by this process.

### BACKGROUND TO THE INVENTION

Aerated food products are widely known, for example food products like mousses, ice cream and whipped cream contain air bubbles which are stabilised in the food products. Gases commonly used for ‘aeration’ include air, nitrogen and carbon dioxide. Two factors are of importance in the development of aerated food products, and these are (i) the foamability of the product while introducing gas into the product during manufacture and (ii) the foam stability during storage, which is whether the gas bubbles tend to disproportionate or coalesce and whether the foam volume is retained during storage. Many additives are known to be included in the creation of stable foams, and these generally are compounds which are present on the gas bubble surface, which means on the gas-liquid interface during manufacturing of the foam. Known additives include proteins such as sodium caseinate and whey, which are highly foamable, and biopolymers, such as carrageenans, guar gum, locust bean gum, pectins, alginates, xanthan gum, gellan, gelatin and mixtures thereof, which are good stabilisers that work by increasing the thickness (or viscosity of the continuous phase). However, although stabilisers used in the art can often maintain the total foam volume, they are poor at inhibiting the coarsening of the foam microstructure, i.e. increase in gas bubble size by processes such as disproportionation and coalescence. Recently, hydrophobins have been proposed to create stable aerated food products. These are surface active proteins that adsorb to the air-water surface, stabilising the foam by forming elastic layers around the bubbles.

EP 1 623 631 Al discloses, in particular, that hydrophobins have been found to provide both excellent foam volume stability and inhibition of coarsening. Moreover, EP 1 623 631 Al is silent on the influence of temperature on foam stability. Further, the levels of hydrophobin required to achieve excellent product stability are relatively low. It is therefore possible to replace some or all of the conventional ingredients used to form and stabilise aerated food products with smaller amounts of hydrophobin.

U.S. Pat. No. 7,338,779 B1 relates to a method to decrease foam formation during cultivation of Trichoderma production host, by using a genetically modified Trichoderma that produces less hydrophobin. Before Trichoderma is cultivated, substrates and ingredients may be sterilised. During fermentation the pH decreases.

WO 2005/068087 A2 relates to methods for coating objects with hydrophobins, and is silent about aeration and food products, as well as on the influence of temperature or foam stability. A solution with hydrophobin is acidified to a temperature below 2, followed by increase to higher than 10.

WO 2011/015504 A2 relates to aerated product containing crosslinked hydrophobin. The influence of temperature is not disclosed.

EP 2 131 676 describes an aerated food product with an overrun of at least 20%, and containing hydrophobin, wherein the food product has a temperature of between 50° C. and 130° C. Nonetheless, and as it will be demonstrated, this is not correct as it has now been discovered that heating hydrophobin solutions can denature the hydrophobin up to a point where it is no longer capable of stabilising a foam.

Nonetheless, during the industrial processing of food products, heat treatment plays a huge role and there is a huge need to be able to heat treat a composition containing hydrophobin, for example for pasteurisation/sterilisation. It has now been found that it is possible, by pH treatment, to allow for a heat treatment which does not denature the hydrophobin.

### Tests and Definitions

Hydrophobins (HFB)

Hydrophobins are a well-defined class of proteins (Wessels, 1997, Adv. Microb.

Physio. 38: 1-45; Wosten, 2001, Annu Rev. Microbiol. 55: 625-646) capable of self-assembly at a hydrophobic/hydrophilic interface, and having a conserved sequence:

(SEQ ID No. 1)
Xₙ-C-X₅₋₉-C-C-X₁₁₋₃₉-C-X₈₋₂₃-C-X₅₋₉-C-C-X₆₋₁₈-C-Xₘ

where X represents any amino acid, and n and m independently represent an integer. Typically, a hydrophobin has a length of up to 125 amino acids. The cysteine residues (C) in the conserved sequence are part of disulphide bridges. In the context of the present invention, the term hydrophobin has a wider meaning to include functionally equivalent proteins still displaying the characteristic of self-assembly at a hydrophobic-hydrophilic interface resulting in a protein film, such as proteins comprising the sequence:

(SEQ ID No. 2)
Xₙ-C-X₁₋₅₀-C-X₀₋₅-C-X₁₋₁₀₀-C-X₁₋₁₀₀-C-X₁₋₅₀-C-X₀₋₅-C-X₁₋₅₀-
C-Xₘ

or parts thereof still displaying the characteristic of self-assembly at a hydrophobic-hydrophilic interface resulting in a protein film. In accordance with the definition of the present invention, self-assembly can be detected by adsorbing the protein to Teflon and using Circular Dichroism to establish the presence of a secondary structure (in general, a-helix) (De Vocht et al., 1998, Biophys. J. 74: 2059-68).

The formation of a film can be established by incubating a Teflon sheet in the protein solution followed by at least three washes with water or buffer (Wosten et al., 1994, Embo. J. 13: 5848-54). The protein film can be visualised by any suitable method, such as labeling with a fluorescent marker or by the use of fluorescent antibodies, as is well established in the art. m and n typically have values ranging from 0 to 2000, but more usually m and n in total are less than 100 or 200. The definition of hydrophobin in the context of the present invention includes fusion proteins of a hydrophobin and another polypeptide as well as conjugates of hydrophobin and other molecules such as polysaccharides.

Hydrophobins identified to date are generally classed as either class I or class II. Both types have been identified in fungi as secreted proteins that self-assemble at hydrophobilic interfaces into amphipathic films. Assemblages of class I hydrophobins are relatively insoluble whereas those of class II hydrophobins readily dissolve in a variety of solvents.

Hydrophobin-like proteins have also been identified in filamentous bacteria, such as Actinomycete and Steptomyces sp. (WO01/74864). These bacterial proteins, by contrast to fungal hydrophobins, form only up to one disulphide bridge since they have only two cysteine residues. Such proteins are an example of functional equivalents to hydrophobins having the consensus sequences shown in SEQ ID Nos. 1 and 2, and are within the scope of the present invention.

The hydrophobins can be obtained by extraction from native sources, such as filamentous fungi, by any suitable process. For example, hydrophobins can be obtained by culturing filamentous fungi that secrete the hydrophobin into the growth medium or by extraction from fungal mycelia with 60% ethanol. It is particularly preferred to isolate hydrophobins from host organisms that naturally secrete hydrophobins. Preferred hosts are hyphomycetes (e.g. Trichoderma), basidiomycetes and ascomycetes. Particularly preferred hosts are food grade organisms, such as Cryphonectria parasitica which secretes a hydrophobin termed cryparin (MacCabe and Van Alfen, 1999, App. Environ. Microbiol 65: 5431-5435).

Alternatively, hydrophobins can be obtained by the use of recombinant technology. For example host cells, typically micro-organisms, may be modified to express hydrophobins and the hydrophobins can then be isolated and used in accordance with the present invention. Techniques for introducing nucleic acid constructs encoding hydrophobins into host cells are well known in the art. More than 34 genes coding for hydrophobins have been cloned, from over 16 fungal species (see for example WO96/41882 which gives the sequence of hydrophobins identified in Agaricus bisporus; and Wosten, 2001, Annu Rev. Microbiol. 55: 625-646). Recombinant technology can also be used to modify hydrophobin sequences or synthesise novel hydrophobins having desired/improved properties.

Typically, an appropriate host cell or organism is transformed by a nucleic acid construct that encodes the desired hydrophobin. The nucleotide sequence coding for the polypeptide can be inserted into a suitable expression vector encoding the necessary elements for transcription and translation and in such a manner that they will be expressed under appropriate conditions (e.g. in proper orientation and correct reading frame and with appropriate targeting and expression sequences). The methods required to construct these expression vectors are well known to those skilled in the art.

A number of expression systems may be used to express the polypeptide coding sequence. These include, but are not limited to, bacteria, fungi (including yeast), insect cell systems, plant cell culture systems and plants all transformed with the appropriate expression vectors. Preferred hosts are those that are considered food grade—‘generally regarded as safe’ (GRAS).

Suitable fungal species, include yeasts such as (but not limited to) those of the genera Saccharomyces, Kluyveromyces, Pichia, Hansenula, Candida, Schizo saccharomyces and the like, and filamentous species such as (but not limited to) those of the genera Aspergillus, Trichoderma, Mucor, Neurospora, Fusarium and the like.

The sequences encoding the hydrophobins are preferably at least 80% identical at the amino acid level to a hydrophobin identified in nature, more preferably at least 95% or 100% identical. However, persons skilled in the art may make conservative substitutions or other amino acid changes that do not reduce the biological activity of the hydrophobin. For the purpose of the invention these hydrophobins possessing this high level of identity to a hydrophobin that naturally occurs are also embraced within the term “hydrophobins”.

Hydrophobins can be purified from culture media or cellular extracts by, for example, the procedure described in WO01/57076 which involves adsorbing the hydrophobin present in a hydrophobin-containing solution to surface and then contacting the surface with a surfactant, such as Tween 20, to elute the hydrophobin from the surface. See also Collen et al., 2002, Biochim Biophys Acta. 1569: 139-50; Calonje et al., 2002, Can. J. Microbiol. 48: 1030-4; Askolin et al., 2001, Appl Microbiol Biotechnol. 57: 124-30; and De Vries et al., 1999, Eur J Biochem. 262: 377-85.

Aerated Food Products

Aerated food products of the invention typically fall into one of four groups—hot, ambient, chilled or frozen. The term “food” includes beverages. Hot food products include beverages such as cappuccino coffee. Ambient aerated food products include whipped cream, marshmallows and bakery products, e.g. bread. Chilled aerated food products include whipped cream, mousses and beverages such as beer, milk shakes and smoothies. Frozen aerated food products include frozen confections such as ice cream, milk ice, frozen yoghurt, sherbet, slushes, frozen custard, water ice, sorbet, granitas and frozen purees.

Preferably the aerated food product is an aerated confectionery product.

The term “aerated” means that gas has been intentionally incorporated into the product, such as by mechanical means. The gas can be any food-grade gas such as air, nitrogen or carbon dioxide. The extent of aeration is typically defined in terms of “overrun”. In the context of the present invention, %overrun is defined in volume terms as:

((volume of the final aerated product—volume of the mix)/volume of the mix)×100%

The amount of overrun present in the product will vary depending on the desired product characteristics. For example, the level of overrun in ice cream is typically from about 70 to 100%, and in confectionery such as mousses the overrun can be as high as 200 to 250 wt %, whereas the overrun in water ices is from 25 to 30%. The level of overrun in some chilled products, ambient products and hot products can be lower, but generally over 10%, e.g. the level of overrun in milkshakes is typically from 10 to 40 wt %.

The amount of hydrophobin present in the product will generally vary depending on the product formulation and volume of the air phase. Typically, the product will contain at least 0.001 wt %, hydrophobin, more preferably at least 0.005 or 0.01 wt %. Typically the product will contain less than 1 wt % hydrophobin. The hydrophobin may be from a single source or a plurality of sources e.g. the hydrophobin can a mixture of two or more different hydrophobin polypeptides.

Preferably the hydrophobin is a class II hydrophobin.

The present invention also encompasses compositions for producing an aerated food product of the invention, which composition comprises a hydrophobin. Such compositions include liquid premixes, for example premixes used in the production of frozen confectionery products, and dry mixes, for example powders, to which an aqueous liquid, such as milk or water, is added prior to or during aeration.

Such compositions include liquid premixes, for example premixes used in the production of frozen confectionery products, and dry mixes, for example powders, to which an aqueous liquid, such as milk or water, is added prior to or during aeration.

The compositions for producing a frozen food product of the invention, will comprise other ingredients, in addition to the hydrophobin, which are normally included in the food product, e.g. sugar, fat, emulsifiers, flavourings etc. The compositions may include all of the remaining ingredients required to make the food product such that the composition is ready to be processed, i.e. aerated, to form an aerated food product of the invention.

Dry compositions for producing an aerated food product of the invention will also comprise other ingredients, in addition to the hydrophobin, which are normally included in the food product, e.g. sugar, fat, emulsifiers, flavourings etc. The compositions may include all of the remaining non-liquid ingredients required to make the food product such that all that the user need only add an aqueous liquid, such as water or milk, and the composition is ready to be processed to form an aerated food product of the invention. These dry compositions, examples of which include powders and granules, can be designed for both industrial and retail use, and benefit from reduced bulk and longer shelf life.

The hydrophobin is added in a form and in an amount such that it is available to stabilise the air phase. By the term “added”, we mean that the hydrophobin is deliberately introduced into the food product for the purpose of taking advantage of its foam stabilising properties. Consequently, where food ingredients are present or added that contain fungal contaminants, which may contain hydrophobin polypeptides, this does not constitute adding hydrophobin within the context of the present invention.

Typically, the hydrophobin is added to the food product in a form such it is capable of self-assembly at an air-liquid surface.

Typically, the hydrophobin is added to the food product or compositions of the invention in an isolated form, typically at least partially purified, such as at least 10% pure, based on weight of solids. By “added in isolated form”, we mean that the hydrophobin is not added as part of a naturally-occurring organism, such as a mushroom, which naturally expresses hydrophobins. Instead, the hydrophobin will typically either have been extracted from a naturally-occurring source or obtained by recombinant expression in a host organism.

### BRIEF DESCRIPTION OF THE INVENTION

It is a first object of the invention to provide a process for treating a food composition containing 0.01 to 15% w/w hydrophobin wherein
the composition pH is first brought to between 1 and 4, preferably under 3.5;
then the composition is heat treated (preferably at a temperature of at least 70° C., more preferably at least 80° C., most preferably at least 110° C.);
then the composition is brought to a pH of between 6 and 7.5.

This allows for the production of a food composition which can be later aerated.

Preferably, after aeration, additional food ingredients are added to the aerated composition. It allows for an aerated foam to first be produced followed by the post addition of any ingredient which could otherwise compete with hyrdophobin during the aeration step.

In a preferred alternative of the invention. the composition is aerated before being brought to a pH of between 6 and 7.5.

It is a second object of the invention to provide a process for treating a food composition containing 0.001 to 1.5% w/w hydrophobin wherein a first solution comprising 0.01 to 15% w/w hydrophobin
a) is brought to a pH between 3 and 4, preferably under 3.5;
b) then the first solution is heat treated at a temperature of at least 70° C. (preferably at least 80° C., more preferably at least 110° C.);
c) then the first solution is brought to a pH of between 6 and 7.5; and wherein a second solution, containing less than 0.001% w/w hydrophobin is heat treated at a temperature of at least 70° C.;
   the first and second solutions then being added together.

Preferably the first solution is aerated before being added to the second solution.

### DESCRIPTION OF FIGURES

FIG. 1. ¹H NMR spectra of pH3 heated HFB and pH6.4 heated HFB.

FIG. 2. Bubble size distributions in non-aerated yazoo, yazoo+pH3 heated HFB foam and. yazoo+pH6.4 heated HFB foam.

FIG. 3. Bubble size distribution of yazoo+pH3 heated HFB foam fresh, after one week, after 3 weeks.

FIG. 4. Bubble size distribution of yazoo+pH6.4 heated HFB foam fresh, after one week, after 3 weeks.

### DETAILED DESCRIPTION OF THE INVENTION

The present invention will be further described in the following examples

### EXAMPLE 1

### Influence of Temperature at pH 6.4

The impact of temperature at pH 6.4 on hydrophobin was studied by carrying DSC analysis at different hydrophobin (HFB) concentration. The results are summarised in table 1.

TABLE 1

| | Onset (° C.) | Peak (° C.) | dH (J/g) |
|---|---|---|---|
| 5% HFB | 99.24 ± 0.01 | 102.8 ± 0.3 | 33 ± 3 |
| 10% HFB | 98.76 ± 0.03 | 102.7 ± 0.3 | 33.1 ± 0.4 |
| 14% HFB | 99.3 ± 0.5 | 102.9 ± 0.3 | 32 ± 5 |

It shows that Onset, peak position and energy are not affected by the concentration of HFB.

Then NMR analysis was carried out at different temperatures at pH 6.4. All these samples were heated at 3° C./min then kept at the target temperature for 0, 5 and 10 minutes respectively, before cooling at 3° C./min.

The results are summarised in table 2, clearly showing the impact of temperature at pH 6.4, impact starting as early as upon heating to 70° C.

TABLE 2

| Temperature (° C.) | 0 mins (±0.03) | 5 mins (±0.02) | 10 mins (±0.02) |
|---|---|---|---|
| Not heated | 1.00 | 1.00 | 1.00 |
| 70 | 0.91 | 0.71 | 0.65 |
| 80 | 0.69 | 0.61 | 0.60 |
| 90 | 0.67 | 0.46 | 0.35 |
| 100 | 0.55 | 0.15 | 0.07 |
| 110 | 0.00 | 0.00 | 0.00 |
| 120 | 0.00 | 0.00 | 0.00 |

Then surface tension and elasticity were assessed, showing that HFB has a large elastic modulus and low surface tension at the air/water interface at pH 6.4. This surface activity is lost on heating to 100° C.

Then again at pH 6.4, foam stability was assessed. A 10% HFB solution was heated at 3° C.min⁻¹ then held at temperature for 5 minutes, then cooled at 3° C.min⁻¹ then foamed in sucrose solution. The stability of the resulting foam was then assessed using a Mastersizer. It unambiguously showed that showing that at temperature of over 100° C., foam stability is lost.

### EXAMPLE 2

### Influence of Temperature at pH 3

The same set of experiments as in Example 1 was carried out at pH 3.

DSC analysis showed that at pH 3 Protein denaturation transition is smaller than at pH 6.4 and partially reversible.

Foam stability at pH 3 showed Foams are more stable at pH3 than at pH6 and foams formed after heating solution to 120° C. at pH3 are stable.

Finally, NMR analysis showed that the change in structure caused by lowering pH is reversible on neutralisation.

### EXAMPLE 3

The above set of evidence led to tests on food compositions to show whether, indeed, it was possible to heat treat a food composition containing HFB and then form a stable foam. This was down by aerating a commercially available Banana milk shake drink (Yazoo).

0.7 ml volumes of concentrated HFB solution at 144.2 mg/g were heated to 120° C. at 3° C.min⁻¹ in a Setaram DSC at native pH (6.4) and acidified at pH 3 by adding concentrated HCI to the hydrophobin solution.

¹H NMR spectra were acquired for each heat treated solution after dilution with D₂O (0.54 ml D₂O and 0.06 ml hydrophobin solution).

The heat treated solutions were added to 11.5% sucrose, 10% glucose, 0.4% xanthan solutions such that the nominal hydrophobin concentration was 0.2% in 60 g solution. These solutions were aerated using a high shear whisk (aerolatte head in dremel drill) for 3 minutes. The approximate overrun was measured according to the volume of the foam in the beaker relative to the volume of the pre-aerated solution.

The foam was then agitated further with an aerolatte to break up the larger bubbles that had risen to the surface.

The bubble size distributions in the hydrophobin foams were measured using the Malvern Mastersizer, using approximately the same volume of material for each sample such that the relative concentrations are qualitatively comparable.

0.4% (w/w) Xanthan was added to banana flavour yazoo milk shake drink, silversoned then heated to 50° C. to dissolve, cooled to 5° C. in a fridge.

150 g of thickened yazoo was added to each hydrophobin foam, stirred with a spatula and poured into a sterile bottle for storage. The overrun of the aerated yazoo was calculated from measurement of the mass of a known volume of aerated relative to thickened Yazoo milk shake drink.

The bubble size in the aerated thickened Yazoo milk shake drink was visualised using optical microscopy.

The volume loss, overrun and bubble size was assessed on storage at 5° C. for 3 weeks.

The ingredients of the yazoo milk shake drink are listed as Semi-skimmed milk, skimmed milk, sugar (4.5%), banana juice from concentrate (1%), stabiliser-gellan gum, natural flavouring, colour-annatto.

The composition is summarised in table 3.

TABLE 3
summary of yazoo milk shake ingredients

| Protein | Sugar | Fat | Fibre | Sodium | Calcium |
|---|---|---|---|---|---|
| 3.1 g | 9.6 g | 1.2 g | trace | 0.05 g | 120 mg |

Results and Discussion

On visual inspection the pH6.4 heated hydrophobin was a turbid and white suspension, whilst the pH3 heated solution was a dark brown solution, as before heating. This suggests much of the protein is denatured on heating at pH6.4 but maintained in it native state on heating at pH3.

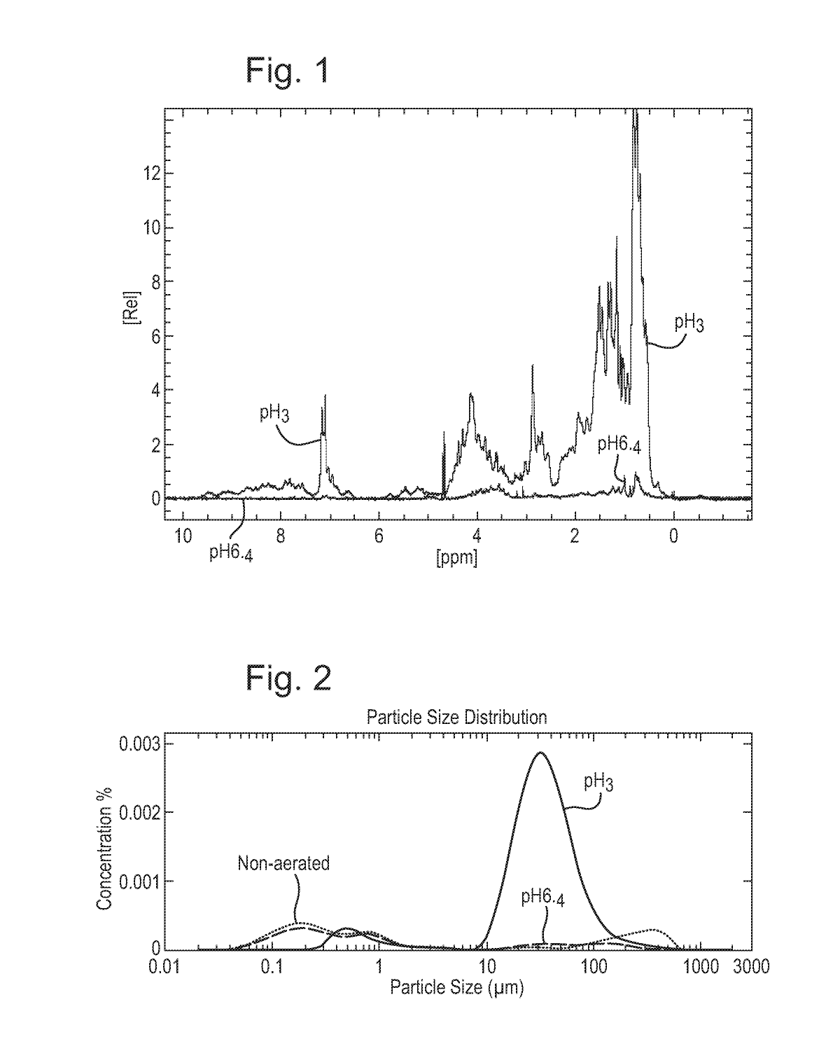

The ¹H NMR spectra in directly measure the protein in solution after heating at pH3 and diluting (neutralising) with D₂O whilst the no native structured hydrophobin is in solution after heating at pH6.4, see FIG. 1.

The overrun of the aerated, diluted hydrophobin solutions before and after adding to the yazoo are summarized in Table 4.

TABLE 4
Overrun of HFB foams and HFB foam + yazoo.

| | Heated at | Heated at |
|---|---|---|
| | pH 3 | pH 6.4 |
| hydrophobin foam (±10%) | 90% | 40% |
| hydrophobin foam + yazoo (±2%) | 18% | 3% |
| hydrophobin foam + yazoo (±2%) 1 week | 11% | −18% |
| hydrophobin foam + yazoo (±2%) 3 weeks | 22% | −22% |

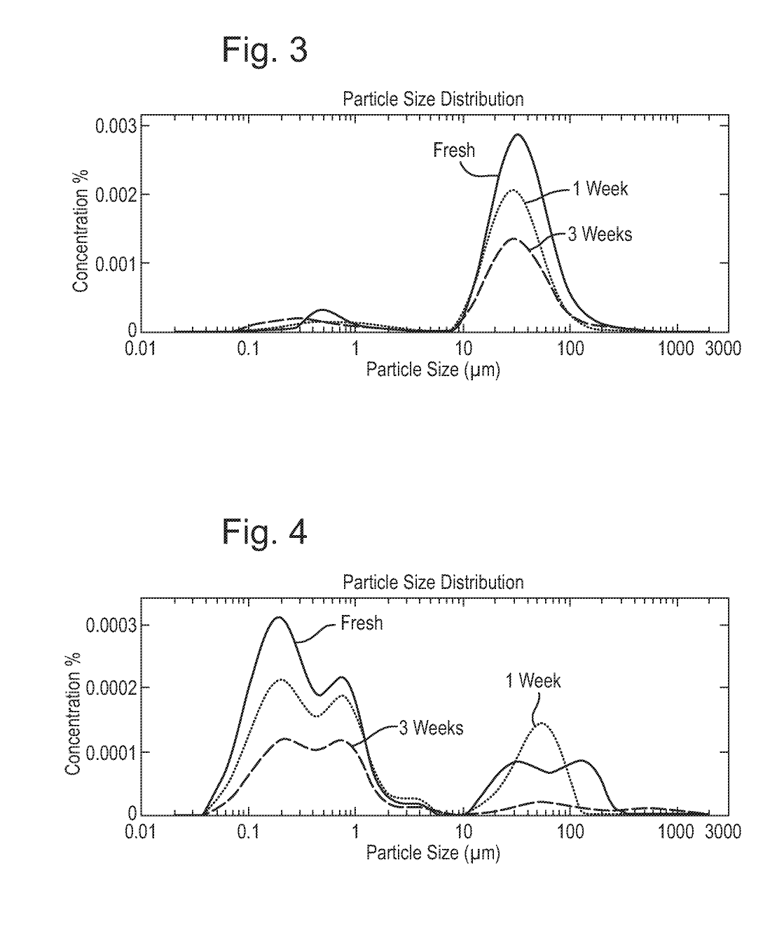

With reference to FIGS. 2, 3, and 4:

The bubble size distributions in these foams after mixing with milk shake are as follows. The pH3 heated, diluted and aerated foam+thickened Yazoo milk shake has a relatively stable bubble size of D[4,3]=43 μm, whilst the pH6.4 heated, diluted and aerated foam thickened Yazoo milk shake has no stable foam, within the experimental uncertainty of this technique.

On storage the bubble size in the pH3 heated hydrophobin foam milkshake is stable over 3 weeks with a D[4,3]=43 μm. There is no evidence in these bubble size distributions of the air phase ripening on storage, i.e. the peak position and width are stable.

The pH6.4 heated hydrophobin foam milk shake contains very little air phase, such that the particle size distribution in is dominated by the fat and protein aggregates (<10 μm) with very little scattering from bubbles (10<μm<100).

Qualitative visualization by light microscopy is in good agreement with the Mastersizer data, in that the thickened Yazoo milk shake+pH6.4 heated hydrophobin foam contains few and large bubbles whilst the thickened Yazoo milk shake+pH3 heated hydrophobin foam contains a lot of small bubbles.

Visual inspection showed that the small bubbles in the pH3 heated hydrophobin foam milk shake can be visualized after storage for 1 and 3 weeks, but very few small and stable bubbles can be seen in the pH 6.4 heated hydrophobin foam milkshake.

Visual inspection of the thickened Yazoo milk shake also shows a difference in colour and volume: the pH3 heated hydrophobin foam milk shake has a larger volume and is a lighter colour, because it includes more air.

Visual inspection clearly shows that the volume of the pH3 hydrophobin foam milk shake is consistently larger than that for the pH6.4 heated hydrophobin foam. The same volumes were used on mixing, so this difference after mixing is a measure of the foam stability. Both aerated milk shakes lose some volume on storage, but the pH 6.4 heated HFB foam milk shake loses most volume, such that it is not aerated after 3 weeks.

Heating hydrophobin solution to 120° C. at native pH denatures the protein such that it does not aerate well and the bubbles are not stable on mixing with thickened Yazoo milk shake.

Heating hydrophobin solution to 120° C. at pH3 preserves much of the hydrophobin structure such that it aerates and forms stable bubbles which survive on mixing with thickened Yazoo milk shake.

### EXAMPLE 4

Various food solutions, hydrophobin with locust bean gum (LBG) and with sugar, were treated in 0.7 ml solution in gasket sealed metal cells heated to 125° C. in a Grant block heater with the time temperature profile summarized in 5. The sample cells were removed after 8 minutes and cooled in an ice bath.

TABLE 5
Summary of temperature profile on heating to 125° C.

| | Time (min) | | | | | | | | |
|---|---|---|---|---|---|---|---|---|---|
| | 0 | 1 | 2 | 3 | 4 | 5 | 6 | 7 | 8 |
| Tem- | 22.5 | 73.4 | 101.2 | 114.4 | 120.2 | 122.8 | 123.9 | 124.5 | 124.7 |
| pera- | | | | | | | | | |
| ture | | | | | | | | | |
| (° C.) | | | | | | | | | |

HFB concentration quantified by hplc.

The 10%HFB samples were diluted with 20% sucrose before aeration with the high shear aerolatte whisk (˜18 000 rpm) for 1 minute.

The foamability was assessed by calculating the overrun from density measurements of the fresh samples.

The foam stability was assessed by visual inspection and measurement of the overrun after 11 days. The foams drained during storage so were gently remixed before measuring the density and calculating the overrun.

Results and Discussion

| | | Percentage of | Over- | Over- |
|---|---|---|---|---|
| | Control Con- | Control Con- | run | run |
| | centration | centration | day 0 | day 11 |
| Sample | (%) | after Heating (%) | (%) | (%) |
| 10% HFB Only pH 3 | 12.17 | 73.3 | 210 | 161 |
| 10% HFB Only pH 6 | 12.32 | 1.5 | 0 | 0 |
| 10% HFB + | 11.96 | 75.2 | 230 | 181 |
| Sucrose pH 3 | | | | |
| 10% HFB + | 12.22 | 1.3 | 0 | 0 |
| Sucrose pH 6 | | | | |
| 10% HFB + | 12.09 | 75.6 | 243 | 187 |
| LBG pH 3 | | | | |
| 10% HFB + | 12.06 | 1.8 | 0 | 0 |
| LBG pH 6 | | | | |

All HFB is irreversibly lost from solution on heating 10% HFB solution, 10%HFB+10% sucrose or 10%HFB+0.1%LBG to 125° C. at pH6.4, whilst 75% of the HFB remains in solution and functional when heated to 125° C. at pH3. The extent of denaturation has been quantified by hplc and the resulting functionality assessed for some of the heated samples.

The HFB denaturation temperature increases with sucrose concentration.

1. Process for treating a food composition containing 0.01 to 15% w/w hydrophobin wherein
a) the composition pH is first brought to between 1 and 4, preferably under 3.5;
b) then the composition is heat treated at a temperature of at least 70° C. (preferably at least 100° C.);
c) then the composition is brought to a pH of between 6 and 7.5.

2. Process according to claim 1, wherein the composition is aerated after step c).

3. Process according to claim 1, wherein the composition is aerated before step c).

4. Process for treating a food composition containing 0.001 to 1.5% w/w hydrophobin, wherein a first solution comprising 0.01 to 15% w/w hydrophobin
a) is brought to a pH between 1 and 4, preferably under 3.5;
b) then the first solution is heat treated at a temperature of at least 70° C. (preferably at least 110° C.);
c) then the first solution is brought to a pH of between 6 and 7.5;
and wherein a second solution, containing less than 0.001% w/w hydrophobin is heat treated at a temperature of at least 70° C.;
the first and second solutions then being added together.

5. Process according to claim 4 wherein the first solution is aerated before being added to the second solution.
